(19) United States
(12) Patent Application Publication
(10) Pub. No.: US 2021/0397956 A1
(43) Pub. Date: Dec. 23, 2021

(54) ACTIVITY LEVEL MEASUREMENT USING DEEP LEARNING AND MACHINE LEARNING

(71) Applicant: THE DUN & BRADSTREET CORPORATION, Short Hills, NJ (US)

(72) Inventors: Teja Rasamsetti, Edison, NJ (US); Dennis Russell, Auburn, ME (US); Karolina Kierzkowski, Westfield, NJ (US); Huanou Liu, Roseland, NJ (US); David Earickson, St. Louis, MO (US); Alla Kramskaia, Warren, NJ (US)

(21) Appl. No.: 17/344,623

(22) Filed: Jun. 10, 2021

Related U.S. Application Data
(60) Provisional application No. 63/038,402, filed on Jun. 12, 2020.

(51) Int. Cl. G06N 3/08

(52) U.S. Cl. CPC G06N 3/08

(57) ABSTRACT

There is provided a method for assessing an activity level of an entity. The method includes (i) receiving source data from a source about a plurality of entities, (ii) analyzing the source data to produce (a) a source data assessment that indicates whether to include the source data in a scored data set, and (b) a calculated accuracy that is a weighted accuracy assessment of the source data, (iii) receiving entity data about an entity of interest, (iv) generating, from the entity data and the calculated accuracy, an entity description that represents attributes of the entity of interest, (v) analyzing the source data assessment and the entity description to produce an activity score that is an estimate of an activity level of the entity of interest, and (vi) issuing a recommendation concerning treatment of the entity of interest based on the activity score.

### CROSS-REFERENCED APPLICATION

This application claims priority to U.S. Provisional Application No. 63/038,402, filed on Jun. 12, 2020, which is incorporated herein in its entirety by reference thereto.

### BACKGROUND

### 1. Field of the Disclosure

The present disclosure relates to a time series technique for evaluating a subject to determine its activity levels including its viability, i.e., its ability to operate successfully. The technique can be employed for evaluation of any subject whose viability is of interest, for example, a machine or a business.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

Complex machinery and businesses undergo lifecycle changes that need to be measured as accurately as possible. For example, an owner or operator of an automobile may want to know when a car will break down in order to repair it. In another example, a sender of Internet communication may wish to stop sending communications to inactive businesses. Present technology to estimate activity levels needs improvement, as consequences of low accuracy leads to legal implications, poor customer experience, and loss of revenue. The growth of data and the ability to capture large volumes of information require newer techniques to improve the estimation of activity levels. New breakthroughs in understanding sources of information and modern technologies associated with artificial intelligence/machine learning (AI/ML) help in better estimates of activity level.

The following documents are incorporated herein in their entirety:
(a) U.S. Patent Application Publication No. 2018/0101771 A1, which is directed toward a system and method for identifying and prioritizing company prospects by training at least one classifier on client company win/loss metrics;
(b) U.S. Patent Application Publication No. 2020/0026759 A1, which is directed toward a method and system for employing a Language Processing machine learning Artificial Intelligence engine to employ word embeddings and term frequency-inverse document frequency to create numerical representations of document meaning in a high dimensional semantic space or an overall semantic direction; and
(c) U.S. Patent Application Publication No. 2020/0342337 A1, which is directed toward a method and system for identifying and classifying Visitor Information tracked on websites to identify Internet Service Providers (ISPs) and non-Internet Service Providers (non-ISPs).

There is a need for a technique that estimates levels of activity of one or more devices or entities among a larger group of devices or entities, with high degree of confidence.

### SUMMARY

There is provided a method for assessing an activity level of an entity. The method includes (i) receiving source data from a source about a plurality of entities, (ii) analyzing the source data to produce (a) a source data assessment that indicates whether to include the source data in a scored data set, and (b) a calculated accuracy that is a weighted accuracy assessment of the source data, (iii) receiving entity data about an entity of interest, (iv) generating, from the entity data and the calculated accuracy, an entity description that represents attributes of the entity of interest, (v) analyzing the source data assessment and the entity description to produce an activity score that is an estimate of an activity level of the entity of interest, and (vi) issuing a recommendation concerning treatment of the entity of interest based on the activity score.

### BRIEF DESCRIPTION OF THE DRAWINGS

FIG. 1 is a block diagram of a system for evaluating the activity level of a subject.

FIG. 2 is a block diagram of program module that is utilized in the system of FIG. 1.

FIG. 3 is a block diagram of a preliminary processing unit.

FIG. 4 is a block diagram of a source data analyzer.

FIG. 5 is a block diagram of an entity feature generator.

FIG. 6 is a block diagram of an activity analyzer.

FIG. 7 is a graph of an activity score of an entity, over time.

A component or a feature that is common to more than one drawing is indicated with the same reference number in each of the drawings.

### DESCRIPTION OF THE PREFERRED EMBODIMENTS

Important entities, such as drilling equipment, are parts of an oil rig, with sensors that provide information about the drilling equipment. These sensors are sources of information and include multiple thermometers, accelerometers, gyroscopes, magnetometers, flow sensors, pressure sensors, etc. In order to determine an activity level of the drilling equipment, information provided by sensors on the oil rig is analyzed. As each sensor is calibrated, maintained and operated differently, analyzing the quality of a sensor is critical to analyzing information output from the sensor. A system that evaluates the activity level ingests data from these sensors, quantifies the quality of the sources, incorporates the quality of the sources to analyze the data from the sources and uses a deep learning/machine learning technique to calculate the activity level. As deep learning/machine learning techniques are sensitive to both training data and yet-to-be-seen input data, quantifying the quality of sources of data improves the accuracy of estimates calculated in accordance with a deep learning/machine learning technique.

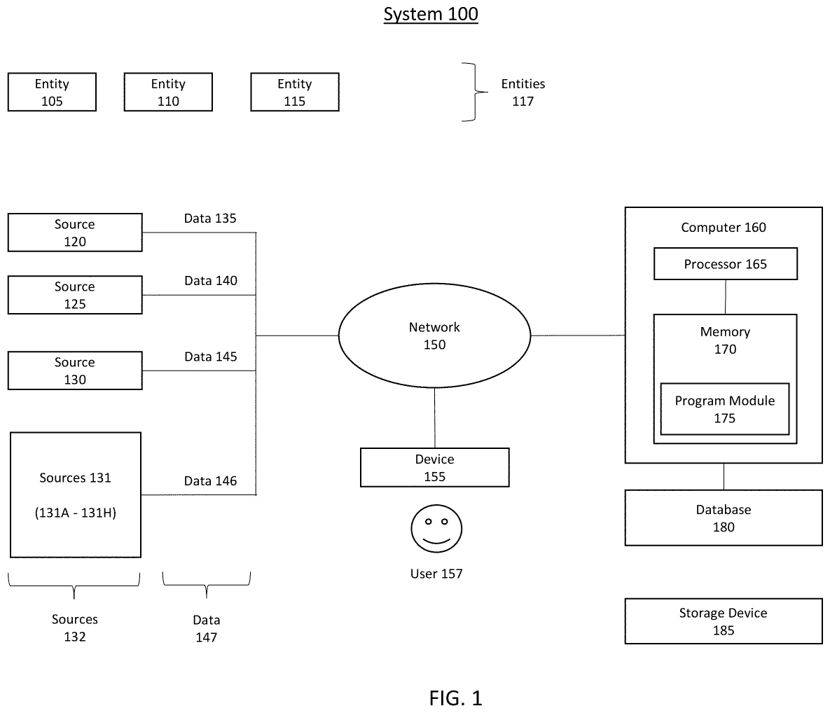

FIG. 1 is a block diagram of a system 100 for evaluating the activity level of a subject. In this regard, system 100 includes entities 105, 110 and 115, sources 120, 125, 130 and 131, a network 150, a device 155, a computer 160, and a database 180.

Entities 105, 110 and 115 are subjects whose activity levels can be evaluated. Examples include, but are not limited to, devices, computer equipment, communications equipment, pumps, oil rigs, automobiles, business entities, and non-profit organizations. The commonality among these entities is that while physical inspection for small individual units is possible, inspection at scale is difficult if not impossible. In practice, their activity levels are monitored or tracked over time. Entities 105, 110 and 115 are collectively referred to as entities 117. Although system 100 is shown as having three such entities, any number of one or more entities is feasible.

Sources 120, 125, 130 and 131 are sources of information about entities 117. Sources 131 represents a group of additional sources designated as sources 131A through 131H. Sources 120, 125, 130 and 131 measure different attributes of the entity activity at similar or different time intervals. Information obtained from a source can be static, quasi-static, or dynamic in nature. The information is of varying levels of accuracy, and accuracy of each source can vary over time. Examples of sources include, but are not limited to, sensors, detectors, websites, social media, public agencies, and private investigators. Information provided by sources 120, 125, 130 and 131 is in the form of data 135, data 140, data 145 and data 146, respectively. Sources 120, 125, 130 and 131 are collectively referred to as sources 132, and data 135, 140, 145 and 146 are collectively referred to as data 147. In practice, any number of one or more sources and corresponding data is feasible.

Network 150 is a data communications network. Network 150 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (0 the Internet, or (g) a telephone network.

Sources 132, device 155, and computer 160 are communicatively coupled to network 150. Communications are conducted via network 150 by way of electronic signals and optical signals that propagate through a wire or optical fiber, or are transmitted and received wirelessly.

Computer 160 includes a processor 165, and a memory 170 that is operationally coupled to processor 165. Although computer 160 is represented herein as a standalone device, it is not limited to such, but instead can be coupled to other devices (not shown) in a distributed processing system.

Processor 165 is an electronic device configured of logic circuitry that responds to and executes instructions.

Memory 170 is a tangible, non-transitory, computer-readable storage device encoded with a computer program. In this regard, memory 170 stores data and instructions, i.e., program code, that are readable and executable by processor 165 for controlling the operation of processor 165. Memory 170 may be implemented in a random access memory (RAM), a hard drive, a read only memory (ROM), or a combination thereof. One of the components of memory 170 is a program module 175.

Program module 175 contains instructions for controlling processor 165 to execute methods described herein. The term “module” is used herein to denote a functional operation that may be embodied either as a stand-alone component or as an integrated configuration of a plurality of subordinate components. Thus, program module 175 may be implemented as a single module or as a plurality of modules that operate in cooperation with one another. Moreover, although program module 175 is described herein as being installed in memory 170, and therefore being implemented in software, it could be implemented in any of hardware (e.g., electronic circuitry), firmware, software, or a combination thereof.

Processor 165 outputs, to device 155, via network 150, a result of an execution of the methods described herein. Although processor 165 is represented herein as a standalone device, in practice, processor 165 can be implemented as a single processor or multiple processors.

Device 155 is a user device, of a user 157 who is interested in the activity level of one or more of entities 117. Device 155 includes an input subsystem, such as a keyboard, a speech recognition subsystem, or a gesture recognition subsystem, for enabling user 157 to communicate information to and from computer 160, and thus, to and from processor 165, via network 150. Device 155 also includes an output device such as a display or a speech synthesizer and a speaker. A cursor control or a touch-sensitive screen allows user 157 to communicate additional information and command selections to processor 165.

While program module 175 is indicated as being already loaded into memory 170, it may be configured on a storage device 185 for subsequent loading into memory 170. Storage device 185 is a tangible, non-transitory, computer-readable storage device that stores program module 175 thereon. Examples of storage device 185 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled to computer 160 via network 150.

Database 180 stores data 147 and other data either in a relational or non-relational format. Although in FIG. 1, database 180 is shown as being directly connected to computer 160, database 180 could be remotely situated from computer 160, and communicatively coupled to computer 160 via network 150. Also, database 180 can be configured as a single device or multiple connected devices in a distributed, e.g., cloud, database system.

In practice, data 147 may contain many, e.g., millions of, data items or data samples. Thus, in practice, data 147 cannot be processed by a human being, but instead, would require a computer such as computer 160. Moreover, data 147 may be asynchronous, and processing thereof would best be handled by a robust computer technology because of the “lumpy” nature of such data. Additionally, computer 160 performs time indexing and time stamping of data, in processing of the data and also in storage and dissemination of the data.

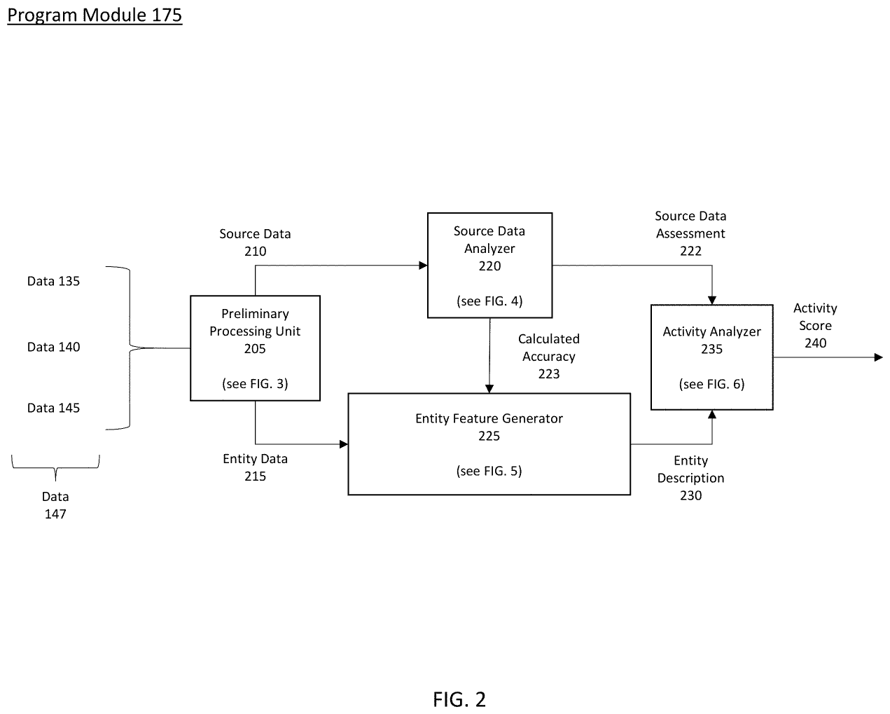

FIG. 2 is a block diagram of program module 175. Program module 175 performs data preprocessing, entity description, analysis and calculations to ingest data 147, and outputs an activity score 240. Subcomponents of program module 175 include a preliminary processing unit 205, a source data analyzer 220, an entity feature generator 225, and an activity analyzer 235.

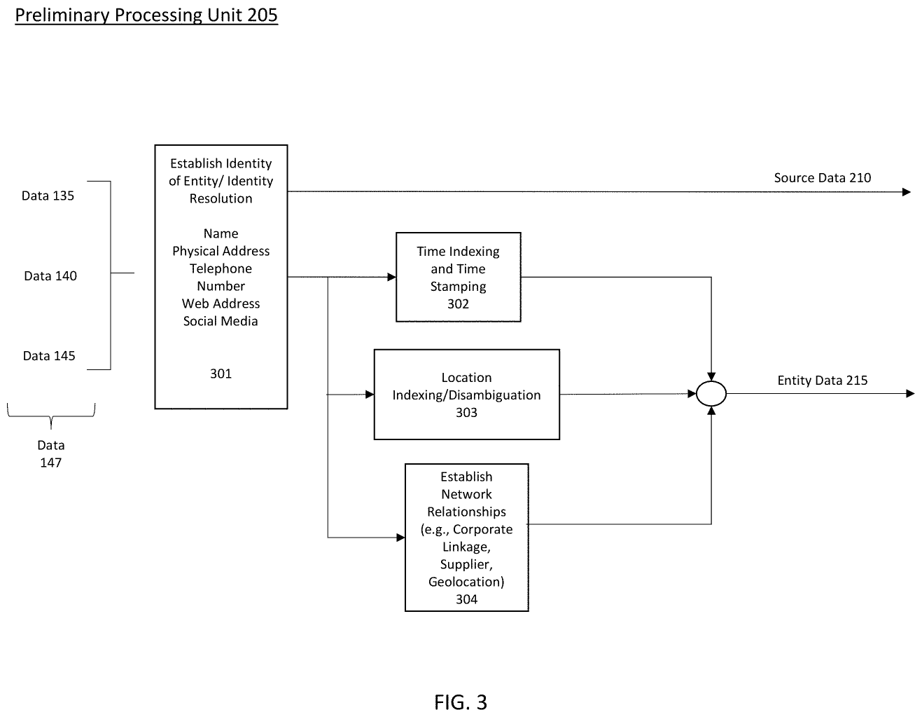

Preliminary processing unit 205 receives data 147, and outputs source data 210 and entity data 215. Source data 210 is data received from a source e.g., source 120, concerning a plurality of entities, e.g., entities 117. Entity data 215 is information about a specific entity of interest, e.g., entity 105. Preliminary processing unit 205 is described in further detail below, with reference to FIG. 3.

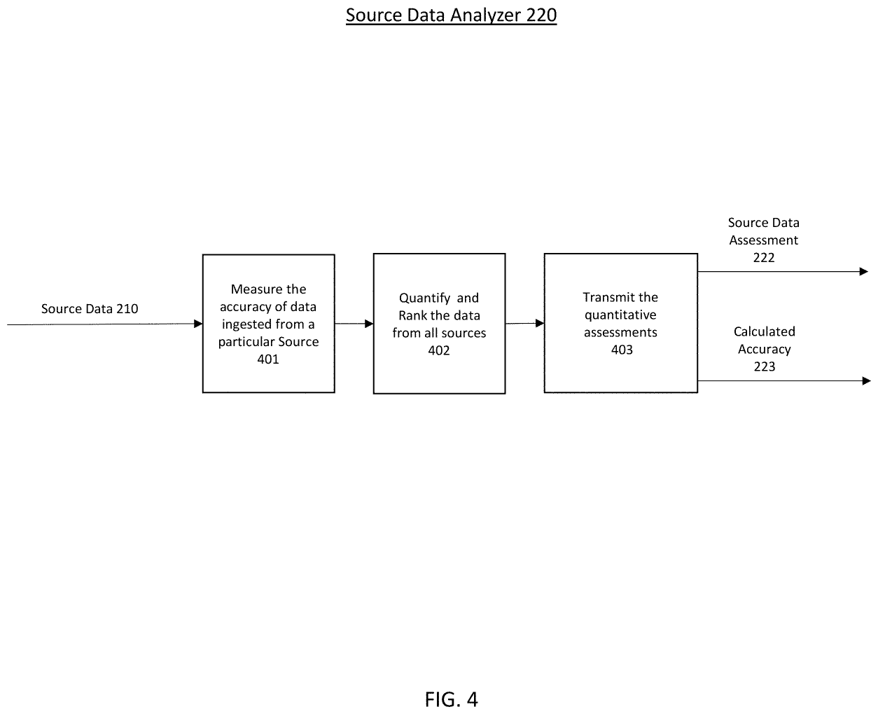

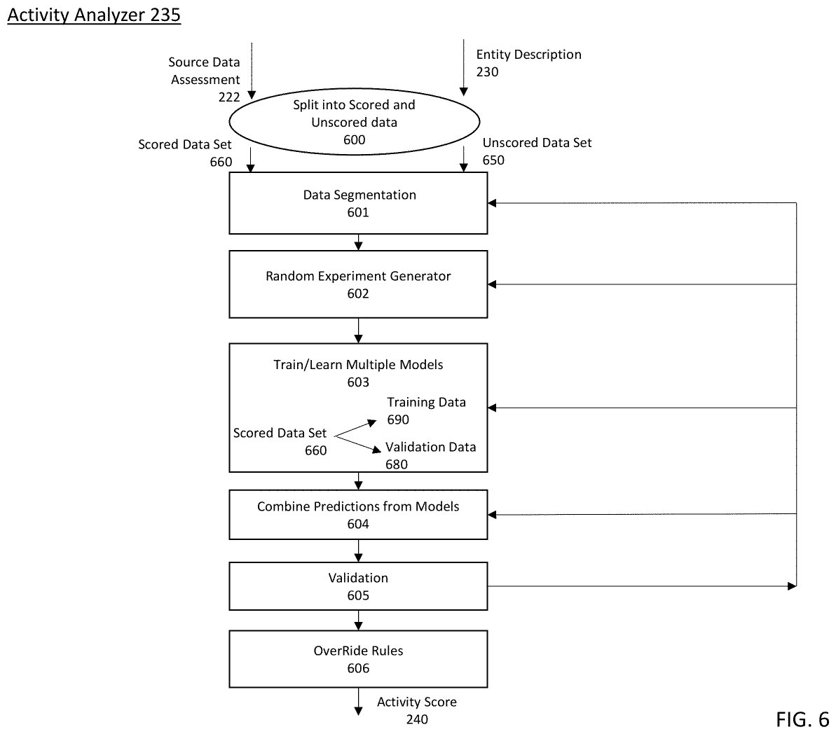

Source data analyzer 220 receives source data 210, and produces a source data assessment 222 and a calculated accuracy 223. Source data assessment 222 is a binary assessment, which is used to decide whether to include an entity into a scored data set 660 as part of operation 600 (see FIG. 6). Calculated accuracy 223 is a weighted accuracy assessment of source data 210. Source data analyzer 220, source data assessment 222, and calculated accuracy 223 are described in further detail below, with reference to FIG. 4.

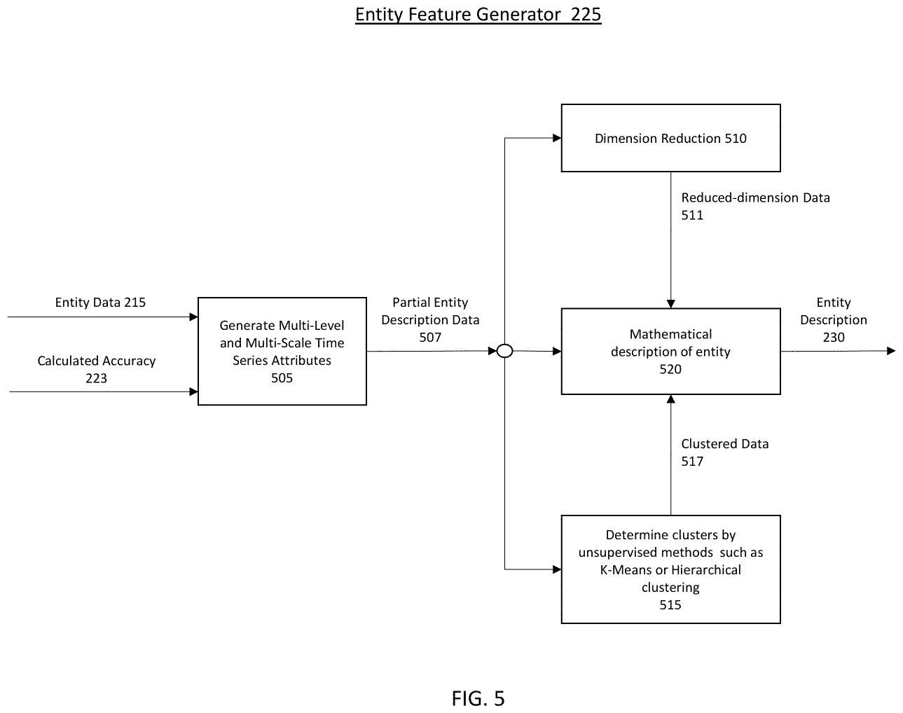

Entity feature generator 225 receives entity data 215 and calculated accuracy 223, and produces an entity description 230. Entity description 230 describes entities in tabular format, where each row describes one entity and columns are different types of mathematical descriptions. Entity feature generator 225 and entity description 230 are described in further detail below, with reference to FIG. 5.

Activity analyzer 235 receives source data assessment 222 and entity description 230, and produces activity score 240. Activity score 240 is an estimate of activity levels of an entity on a scale of 0 to 1, with higher values indicating more activity. Activity analyzer 235 is described in further detail below, with reference to FIG. 6.

FIG. 3 is a block diagram of preliminary processing unit 205.

In operation 301, preliminary processing unit 205 receives data 147 and establishes the identity of an entity, i.e., one of entities 117. In order to establish the identity of an entity, preliminary processing unit 205 considers physical and/or digital attributes such as name of business, geolocation using latitude/longitude or physical address, telephone number and digital profile information such as Internet Protocol (IP) address, web address and social media profile. Preliminary processing unit 205 then uses reference tables in database 180, where all entities and corresponding serial numbers are stored, to match one of entities 117. Assume, for example, that entity 105 is a business that is being evaluated by system 100. A DUNS number is a unique identifier of a business. Accordingly, preliminary processing unit 205 attaches the data to a given DUNS number for entity 105. Operation 301 outputs source data 210, as described in FIG. 4.

Prior to operation 301, all data enters the system first through a single nodal point. The source data and entity data undergo different processes/transformation in subsequent steps. Operation 301 passes data 147 on to operations 302, 303 and 304.

In operation 302, data 147 from sources 132 are time stamped and indexed as different elements of data 147 are static/semi-static/dynamic in nature. Wherever gaps in data 147 are present, operation 302 uses imputing techniques to have data available at every time-stamp. If imputing a result is not possible, operation 302 leaves the result as a NULL value.

In operation 303, similarly to time stamping and indexing, data 147 are location indexed using latitude and longitude.

Operation 304 receives data 147 and establishes network relationships, for example, relationships between entities 117. Some types of relationships are (a) corporate linkages/network relationships, (b) geolocation relationships, i.e., which entities are close to each other (businesses or machines), and (c) supplier-vendor relationships. Supplier-vendor relationships are particularly important to know in a case of a supply chain disruption.

Operations 302, 303 and 304, collectively, produce entity data 215.

Entity data 215 uses independent variables, also referred to as features, to best describe the entity. A dependent variable, also referred to as a target variable, is activity score 240, and is not part of entity data 215. For businesses, entity data 215 may include one or more of commercial trade experiences, credit inquiries, money spent in commercial tractions, and marketing inquiries. For example, for drilling equipment, entity data 215 may include sensor readings from an accelerometer, a magnetometer, a gyroscope, a rotating vector, a pressure sensors, and/or a flow sensor.

FIG. 4 is a block diagram of source data analyzer 220. Performance of system 100 is sensitive to inputs from sources 132, and therefore, the accuracy of the output from each of sources 132 is measured. Source data analyzer 220 measures this accuracy, also referred to as the quality of data 147 from sources 132. Sources 132 will likely have varying levels of accuracy over time. For example, the measurements of a sensor may drift over time.

Operation 401 receives source data 210, and measures the accuracy of data from each of sources 132 against a verified population sample. A verified population is developed using manual inspections by qualified personal. As historical data is available in database 180 in time-indexed format, operation 401 can measure how the accuracy is changing at different time intervals and interpolate for any intermediate times.

TABLE 1, below, illustrates accuracy measurement based on sources 120, 125, 130 and 131, at a given time instance. The columns of the table are source number, percentage active(pct_0), percentage inactive(pct_1), count of active(count_0) and count of inactive(count_1). In order to calculate the counts and percentages, a population sample of entities, e.g., 10000 entities, similar to entity 105, is verified by a technician or private investigator. If the verification confirms 4302 active entities and 5698 inactive entities, the count_0 and count_1 column value for each of the sources 132 is filled first. Count_0 is number of active entities identified by each of sources 132 out of 4302 verified active entities. Count_1 is number of inactive entities identified by each of sources 132 out of 4302 verified active entities. The percentage columns are subsequently filled from the count columns. Pct_0 is percentage of active and pct_1 is percentage of inactive.

TABLE 1
Accuracy measurement for sources

| Sources | pct_0 | pct_1 | count_0 | count_1 |
|---|---|---|---|---|
| Source 120 | 0.948617 | 0.051383 | 480 | 26 |
| Source 125 | 0.919355 | 0.080645 | 399 | 35 |
| Source 130 | 0.622484 | 0.377516 | 897 | 544 |
| Source 131A | 0.577558 | 0.422442 | 175 | 128 |
| Source 131B | 0.564356 | 0.435644 | 228 | 176 |
| Source 131C | 0.507331 | 0.492669 | 173 | 168 |
| Source 131D | 0.459459 | 0.540541 | 153 | 180 |
| Source 131E | 0.468445 | 0.531555 | 720 | 817 |
| Source 131F | 0.538642 | 0.461358 | 230 | 197 |
| Source 131G | 0.256098 | 0.743902 | 147 | 427 |
| Source 131H | 0.189189 | 0.810811 | 700 | 3000 |

Operation 402 ranks the accuracy of source data 210 based on the measurement from operation 401. Rank is calculated by sorting the pct_0 in descending order.

Operation 403 outputs two pieces of information, namely source data assessment 222 and calculated accuracy 223. Calculated accuracy 223 is the calculated accuracy of sources 132 as measured in operation 401 (column pct_0 in TABLE 1). Source data assessment 222 helps determine whether an entity belongs to a scored data set 660 (see FIG. 6) or not. The determination by source data assessment 222 is used by activity analyzer 235 in the following manner:
a) source data analyzer 220 will accept entity 105 to be part of scored data set 660 when source 120 has data 135 about entity 105, and accuracy of source 120(pct_0 in TABLE 1) is greater than 80%;
b) source data analyzer 220 will accept entity 110 to be part of scored data set 660 when source 125 has data 140 about entity 110, and accuracy of source 125(pct_0 in TABLE 1) is greater than 80%;
c) source data analyzer 220 will not accept the remaining sources in TABLE 1 as part of source data assessment 222 whenever pct_0 is less than 80%.

FIG. 5 is a block diagram of entity feature generator 225.

Independent variables for scored data set 660 and unscored data set 650 are calculated in entity feature generator 225. As mentioned above, entity feature generator 225 receives entity data 215 and calculated accuracy 223, and produces entity description 230. In this regard, entity feature generator 225 converts entity data 215 and calculated accuracy 223 into entity description 230 for ingestion by activity analyzer 235.

In operation 505, aggregate statistics of entity data 215 are calculated. Aggregate statistics are calculated over a time window and include statistics such as counts, sums and number of unique counts. As an example of a count statistic, assume Bank XYZ (BXYZ) is inquiring about a Hair Salon in Short Hills, N.J. using a product p1. The Hair Salon would be one of entities 117. For each time window, operation 505 counts the number of inquiries from BXYZ across all products and the number of inquiries from all customers using product p1.

Operation 505 also calculates multi-scale statistics. For example, calculations, similar to those described in previous paragraphs, can be over multiple time windows rather than one time window.

Operation 505 also calculates multi-level statistics. Multi-level statistics are at a higher grouping than the source or the entity. In the previous example where the Bank XYZ (BXYZ) is inquiring about a Hair Salon in Short Hills, N.J., multi-level statistics would be the number of inquiries from all financial institutions (the 4-digit Standard Industrial Classification (SIC) code for financial institutions such as BXYZ) instead of just one financial institution (BXYZ). Another example of multi-level statistics could be the number of inquiries from BXYZ to all businesses within a certain zip code or region such as Short Hills, N.J.

TABLE 2 and TABLE 3, below, show an example of how entity data 215 are transformed by entity feature generator 225. TABLE 2 shows entity data 215 over a two year window (i.e., two years between Jun. 20, 2012 and Jun. 13, 2018). TABLE 3 shows transformation by entity feature generator 225 by counting the number of months there has been an inquiry over a one-year time window (i.e., one year between Jun. 12, 2020 and Jun. 13, 2019) for a variety of different sources 132.

TABLE 2 is a log of entity data 215 as recorded by database 180 before transformations. Assume a reference date of Jun. 12, 2020. In TABLE 2, the columns represent (a) entity number, (b) time that the data was acquired by the source, (c) source number providing the data, (d) product, which identifies a device through which the source provided the data, and (e) lag, which is the amount of time between when the data was acquired, and the reference date. In practice, the entity number may be a DUNS number.

TABLE 2
Entity data 215 recorded in database 180 before transformations

| (a) | (b) | (c) | (d) | (e) Lag |
|---|---|---|---|---|
| Entity number | Time | Source Number (SN) | Product | (months) |
| 1003081 | Jun. 14, 2018 | 131B | p18 | 24 |
| 1003081 | Jun. 16, 2018 | 120 | p9 | 24 |
| 1003081 | Dec. 22, 2018 | 125 | p18 | 18 |
| 1003081 | Oct. 14, 2019 | 125 | p13 | 8 |
| 1003081 | Oct. 22, 2019 | 125 | p18 | 8 |
| 1003081 | Apr. 14, 2020 | 131B | p18 | 2 |

TABLE 3 illustrates the data transformation by calculating aggregate statistics as described earlier. It shows the number of months where there were inquiries and the total number of inquiries made by a source in one year.

TABLE 3
Count and Sum statistics for each source over one year

| Entity number | SN125_1yr_C | SN131B_1yr_C | SN120_1yr_C | SN125_1yr_S | SN131B_1yr_S | SN120_1yr_S |
|---|---|---|---|---|---|---|
| 1003081 | 1 | 1 | 0 | 2 | 1 | 0 |

Like TABLE 3, another table can be created for each product over one year. Similar tables can also be constructed for a different time window than one year.

Operation 505 also combines entity data 215 with calculated accuracy 223 from operation 403 to create weighted statistics such as weighted count and weighted sum. Calculated accuracy 223 is the column “Weights” in TABLE 4. TABLE 4 and TABLE 5 show data 147 and its transformation using weighted statistics.

TABLE 4 combines TABLE 1 and TABLE 2. The weights column corresponding to each source is included. The remaining columns are the same as in TABLE 2. These columns are entity number, date inquired, source number, product used and time lag (in months).

TABLE 4
Entity data 215 along with weights for
each source before transformations.

| Entity | | Source Number | | Lag | |
|---|---|---|---|---|---|
| number | Time | (SN) | Product | (months) | Weights |
| 1003081 | Jun. 14, 2018 | 131B | p18 | 24 | 0.564 |
| 1003081 | Jun. 16, 2018 | 120 | p9 | 24 | 0.948 |
| 1003081 | Dec. 22, 2018 | 125 | p18 | 18 | 0.919 |
| 1003081 | Oct. 14, 2019 | 125 | p13 | 8 | 0.919 |
| 1003081 | Oct. 22, 2019 | 125 | p18 | 8 | 0.919 |
| 1003081 | Apr. 14, 2020 | 131B | p18 | 2 | 0.564 |

TABLE 5 is like TABLE 3 and the aggregated statistics are calculated by multiplying the weights corresponding to each source.

TABLE 5
Weighted count and Weighted sum statistics for each source over one year

| Entity number | W125 _1yr_C | W131B _1yr_C | W120 _1yr_C | W125 _1yr_S | W131B _1yr_S | W120 _1yr_S |
|---|---|---|---|---|---|---|
| 1003081 | 0.919 | 0.564 | 0 | 1.838 | 0.564 | 0 |

Operation 505 can also be applied to any machinery. For example, entity 117 could be a device such as a directional sensor package in an oil and gas directional drilling tool, and sources 132 could be accelerometers and magnetometers, e.g., source 120 could be an accelerometer, and source 125 could be a magnetometer.

An example of an accuracy table for machines measuring accuracy of sources (e.g., accelerometers and magnetometers) is TABLE 6 and TABLE 7 (before and after operation 505). Calculated accuracy 223 is Weights_Accelerometer in TABLE 6. Weights_Accelerometer is obtained while calibrating the accelerometers in a lab or office setting. So, source data analyzer 220 was executed while calibrating the accelerometers in a lab or office setting.

TABLE 6
Accuracy measurement for sensors
as sources expressed as weights

| Sensor | | | | |
|---|---|---|---|---|
| Package | | Magnetometer | Accelerometer | |
| Serial | | Serial | Serial | Weights_ |
| Number | Time | Number | Number | Accelerometer |
| 2003080 | Jan. 31, 2018 | 756 | 125 | 0.98 |
| 2003080 | Mar. 5, 2018 | 147 | 114 | 0.99 |
| 2003080 | Apr. 10, 2018 | 147 | 135 | 0.99 |
| 2003080 | Jun. 16, 2019 | 147 | 125 | 0.97 |
| 2003080 | Jul. 16, 2019 | 147 | 125 | 0.97 |
| 2003080 | Apr. 4, 2020 | 148 | 114 | 0.98 |

TABLE 7 shows the coefficients of multiplication for accelerometer readings based on when it was used. The column values indicate the sensor serial number and time of usage.

TABLE 7
Accelerometer coefficients to multiply with for each sensor.

| Sensor Package | W_Accel | W_Accel | W_Accel | W_Accel |
|---|---|---|---|---|
| Serial Number | _114_2020 | _125_2018 | _114_2018 | _125_2019 |
| 105 | 0.98 | 0.98 | 0.99 | 0.97 |

Operation 505 also measures the time intervals of no data 147 from sources 132. Missing values are calculated in operation 505 by interpolation techniques such as linear interpolation.

For sensor data, operation 505 also includes a low pass filter to remove high frequency noise.

For sensor data, calibration can be done beyond a lab or office setting by using a more sensitive, or accurate, accelerometer package along with a standard accelerometer package. So, the drilling equipment will have both the standard and the more sensitive package. The difference in response between the more sensitive accelerometer package and the standard accelerometer package is used to calculate the weights. While the more sensitive accelerometer package is often more expensive and available in limited quantities, it can be used as a proxy for calibration.

In practice, operation 505 therefore creates data with a large number of columns (high dimension) because sources 132 describe each entity through many types of data 147 over a long span of time.

Operation 505 produces partial entity description data 507. Partial entity description data 507 includes categorical and continuous attributes of the entity such as total hours of sensor usage, age of business, physical location of entity, rating of a business, manufacturer of a sensor etc. Partial entity description data 507 also includes the time-based transformations of data 147 that are described above.

Partial entity description data 507 is provided to each of operations 510, 520 and 515. Operations 510, 520 and 515 may use all partial entity description data 507, or a subset of partial entity description data 507 that is relevant to their respective operations.

Operation 510 receives partial entity description data 507 and uses principal component analysis (PCA) to linearly transform partial entity description data 507 into data having fewer dimensions (or columns), i.e., reduced-dimension data 511. Partial entity description data 507 is a data with large number of columns, and as such can lead to inaccurate predictions by machine learning models in activity analyzer 235. A low dimensional representation, i.e., reduced-dimension data 511, can help in better training by machine learning models. Moreover, user 157 can explore reduced-dimension data 511 and identify patterns. For example, assume partial entity description data 507 of entities 117 contains 1000 attributes (or features). Reduced-dimension data 511 could contain the first 10 components of a PCA, and as such, reduced-dimension data 511 of entities 117 would contain 10 attributes.

Operation 515 receives partial entity description data 507, and groups partial entity description data 507 using clustering techniques such as KMeans or hierarchical clustering, and thus produces clustered data 517. Identifying clusters of entities helps in knowing whether there are underlying relationships between entities irrespective of their activity levels or any other specific outcome. An example of clustered data 517 for entities 117 could be 2 attributes. The 2 attributes are the cluster numbers obtained from KMeans clustering and hierarchical clustering.

Operation 520 receives partial entity description data 507, reduced-dimension data 511, and clustered data 517, and combines them to produce a mathematical description of the entity in the form of entity description 230. Continuing the example from previous two paragraphs for the description of entities 117, if partial entity description data 507 has 1000 attributes, clustered data 517 has 2 attributes and reduced-dimension 511 has 10 attributes, then entity description 230 will have 1012 attributes.

The TABLE 8 is a sample mathematical description of all the entities, where each row represents one entity and each column is one type of data transformation (such as an aggregate statistic)

TABLE 8 is Entity Description 230

| Entity | SN125 | SN131B | | W131B | W120 |
|---|---|---|---|---|---|
| number | _lyr_C | _lyr_C | . . . | _3yr_S | _3yr_S |
| 1003081 | 1 | 1 | | 0.564 | 0 |
| 1003082 | 3 | 0 | | 0.765 | 0.067 |
| . | | | | | |
| . | | | | | |
| . | | | | | |
| 9996099 | 0 | 2 | | 0.866 | 0 |

FIG. 6 is a block diagram of activity analyzer 235.

Operation 600 receives source data assessment 222 and entity description 230, and splits them into scored data set 660 and unscored data set 650. More specifically, based on source data assessment 222, activity analyzer 235 determines which entities are part of scored data set 660. An unscored data set 650 (see FIG. 6) contains data from source data assessment 222 and entity description 230 pertaining to entities whose activity levels are to be determined in activity analyzer 235, to yield activity score 240. Activity scores 240 are dependent variables because they have been determined by source data analyzer 220 and activity analyzer 235.

The actual activity score 240 for scored data set 660 containing only sensors is a binary value, e.g., 0 or 1. For businesses, the actual activity score 240 for scored data set 660 varies from 0 or 7. The scale is based on the level of predictive data available for a company. TABLE 9, below, shows the levels for scored data set.

TABLE 9
Description of scale used as target variables

| Scale/Levels | Description |
|---|---|
| 0 | Basic firmographics, and no trade or financial attributes |
| 1 | Basic firmographics, trace commercial trading activity, |
| | and no financial attributes |
| 2 | Rich firmographics, sparse commercial trading activity, |
| | and no financial attributes |
| 3 | Rich firmographics, partial commercial trading activity, |
| | and no financial attributes |
| 4 | Rich firmographics, extensive commercial trading activity, |
| | and no financial attributes |
| 5 | Rich firmographics, extensive commercial trading activity, |
| | and/or basic financial attributes |
| 6 | Rich firmographics, extensive commercial trading activity, |
| | and comprehensive financial attributes |
| 7 | Publicly Traded Company |

TABLE 10 provides an example to describe operation 600. We assume a subset of entities 117 have data 147 from sources 120, 125 and 131B, as described below. As quality of predictions by a deep leaning or machine learning model is sensitive to training data, only data 147 provided by sources providing high quality data is used as inputs for training in activity analyzer 235.

TABLE 10 indicates whether a source has information about an entity. The columns of the table are each individual source and the rows are entities. 1 indicates that information is available and 0 indicates that information is not available.

TABLE 10 is a reference table to indicate whether a source has information about an entity

| Entity number | Source 125 | Source 131B | Source 131C |
|---|---|---|---|
| 1003080 | 1 | 0 | 0 |
| 1003082 | 1 | 0 | 0 |
| 1003083 | 1 | 1 | 0 |
| 1003056 | 0 | 1 | 0 |
| 1003085 | 0 | 0 | 1 |
| 1003071 | 0 | 0 | 1 |

Operation 600 uses information from TABLE 1 and TABLE 10 to select entities for scored data 660 and unscored data 650. Select active entities from those sources that provide high quality data, such as a threshold pct_0 greater than 0.8. Recall, from TABLE 1, that source 125 satisfied this threshold.

TABLE 11 is a sample scored data set 660 with two columns. The columns are entity numbers and corresponding scores. In TABLE 11, the actual scores corresponding to each entity number is based on the information provided by source 125, because source 125 satisfied the 0.8 threshold. For TABLE 11, scored data set 660 will include entity numbers 1003080, 1003082, 1003083. Thus, unscored data set 650 will include 1003056, 1003085, 1003071.

TABLE 11
Sample Scored Data Set 660

| Entity number | scores |
|---|---|
| 1003080 | 1 |
| 1003082 | 0 |
| 1003083 | 0 |

Operation 601 segments unscored data set 650 and scored data set 660, using the same segmentation criterion for each of them. Examples of segmentation criterion include, but are not limited to, (a) industry code, (b) industry type, (c) geolocation (city/county/state), and (d) no segment/random sample.

Activity analyzer 235 utilizes a deep learning and/or machine learning technique, and operation 602 generates reproducible results for that technique. Although deep learning models use non-deterministic methods for many reasons, operation 602 minimizes such number of methods. Wherever non-deterministic methods are necessary, randomness in several operations within processor 165 are fixed to a constant seed value. Results within 1% of each other are assumed to be identical. For example, operation 602 can be implemented as a random experiment generator that generates multiple training sets from scored data set 660, to run numerical experiments either sequentially or parallelly. Deep learning and machine learning techniques use stochastic techniques in their search of an optimum solution that minimizes error while estimating activity score 240. A computer processor-based stochastic solution may overfit for training data 690. Experiments with different samples of scored data set 660 in operation 602 ensures that the stochastic-based modeling approaches (AI/ML models) provides a generalized solution rather than one that gives best accuracy only for a particular subset of scored data set 660. The design of the random experiments can also be controlled by user 157 to ensure the performance of each experiment is tracked based on an accuracy metric and reproducibility of results. Other controlled experiments involve changing the hyperparameters of a deep learning/machine learning method in operation 603. The changes in hyperparameters will be described in greater detail in FIG. 6. The combination of attributes and hyperparameters for every experiment and the resulting accuracy is also tracked in operation 602. If the absence of an attribute(s) is not changing the accuracy metric (within a threshold), the attribute is removed from further experiments.

Gradient boosting is a machine learning technique for regression and classification problems, which produces a prediction model in the form of an ensemble of weak prediction models, typically decision trees. Feature importance tables (outputs of a gradient boosting model) are also used by operation 602 to determine whether attributes can be removed from further experiments. The experiments in operation 602 include intentionally changing training data 690 or validation data 680, and tracking changes in the accuracy metric. Training data 690 and validation data 680 are obtained from source data 660.

The experiments in operation 602 can include scored data set 660 being normalized, for example, on a scale of 0 to 1.

The experiments in operation 602 will include changing a random seed of processor 165, applying a machine learning model in operation 602, observing the accuracy metric, and tracking the attributes with least feature importance.

The experiments in operation 602 will include randomly changing the scores of scored data set 660, applying a gradient boosting model from operation 602, observing the accuracy metric and tracking the attributes with least feature importance.

Operation 603 learns/trains/fits multiple methods from a choice of deep learning or gradient boosting models. The input training data are independent variables in scored data set 660 obtained from operations 601 and 602. The methods are broadly categorized as gradient boosting or deep learning.

For example, in operation 603, predictions for the unscored data 650 are made after training with gradient boosting methods, such as LightGBM or XGBoost, or a deep learning method, such as recurrent neural networks (RNN).

Following are the steps of implementing a gradient boosting method (GBM).
Step 1) Operation 603 splits scored data set 660 into two new data sets. Scored data set 660 is randomly split into training data 690 and validation data 680 in a ratio of 80:20.
Step 2) A GBM model is trained/fitted using training data 690. For binary target variables, the GBM model maximizes the accuracy evaluation metric AUC and for scaled target variable the GBM model minimizes the mean squared error. AUC is the probability that a model will rank a randomly chosen positive instance higher than a randomly chosen negative instance. Mean squared error calculates the average squared difference between the predicted values and the actual values.
Step 3) While training the model, validation data 680 is used as an evaluation data set to compare the progress of the training phase of the model at each iteration. When the progress of the training phase stops, the best number of iterations is stored.
Step 4) After conclusion of the training process, the model is ready for making a prediction of the unscored data 650.
Step 5) Some other choices of hyperparameters that can be used in the training process and get better accuracy include depth of the tree, regularization parameter(s), number of leaves, and learning rate.
Step 6) The choices mentioned in Step 5 are selection criterion for experiments in operation 602, or input parameters in operation 603.
Step 7) The GBM model also outputs the importance of each attribute in maximizing the evaluation metric, also called as “feature importance”. The “feature importance” for each experiment is transmitted to the random experiment generator, i.e., operation 602, where the least important attributes, for example the least important 5% of the attributes, can be removed.

TABLE 12 is an example of a “feature importance” table. Among many attributes used by the GBM model, TABLE 12 lists the importance for only those attributes described in TABLE 12.

TABLE 12 has two columns, namely the feature and its importance. The importance is calculated based on how valuable or useful each feature is while constructing the model for making predictions.

TABLE 12
The importance of each feature in a GBM model

| Feature | Importance |
|---|---|
| W_Accel_114_2020 | 5858 |
| W_Accel_125_2020 | 4789 |
| W_Accel_125_oneyear | 3380 |
| W_Accel_125_oneyear | 2236 |

In operation 603, deep learning techniques such as RNN and convolutional neural networks (CNN) are used for activity level determination, i.e., activity score 240. The description of the implementation steps of long short-term models (LSTM), a specialized type of RNNs, is listed below.
Step 1) In operation 600 of activity analyzer 235, categorical variables in both scored data set 660 and unscored data set 650 are represented as a vector using entity embedding (unlike for continuous variables). Entity embedding allows representation of categorical variables in a continuous way while revealing intrinsic properties.
Step 2) The categorical variables from Step 1 and the remaining continuous variables of the scored data set 660 and unscored data set 650 are concatenated.
Step 3) Scored data set 660 is split into training data 690 and validation data 680 in a ratio of 80:20.
Step 4) A deep learning model is designed with one set of hyperparameters. The hyperparameters include number of dense and batch normalized layers, activation functions, optimizers (such as Adam, SGD), learning rate, batch size and dropout.
Step 5) After the deep learning model from Step 4 is ready, operation 603 trains a deep learning model for best possible accuracy, while simultaneously using validation data 680 for intermediate evaluation at each calculation. The results of training one epoch completely are stored in callbacks. Callbacks enable activity analyzer 235 to continue the training process until there is no improvement of accuracy metric and refer to the calculations that resulted in the best accuracy metric.
Step 6) After the training process stops because of no improvement in the accuracy, we have a model ready for making predictions.
Step 7) Other models are possible by changing the hyperparameters described in Step 4 and repeating Steps 5 and 6. If only a single best model is required, the model with the best accuracy metric for the validation data 680 is selected. The remaining models are saved in database 180 if they are required for future operations.

In operation 603, probabilistic models can also be used to make predictions instead of a deep learning or machine learning methods such as AutoRegressive Integrated Moving Average (ARIMA), Exponential Smoothing or State Space models such as Kalman Filters can be used for entities 117 which have more clearly defined periodic behavior.

In operation 604, predictions are made using the trained models from operation 603. Predictions from individual models are combined either through linear or nonlinear combination. Predictions from an individual model can also be an attribute for another model.

Operation 605 validates the predictions against validation data 680 in scored data set 660. Operation 605 checks for errors in the predictions, and depending on the errors, repeats operations 601, 602 and 603 until the error is below a threshold. If the error exceeds the threshold, depending on the difference between the actuals and predicted values, the feedback loop selects one of operations 601, 602, 603, 604. Moreover, the higher the difference, the earlier the operation selected. Thus, operation 604 is selected for marginal deviation differences, and operation 601 is selected for highest deviation.

Operation 606 uses external information that was not part of data 147 to adjust for activity levels. For example, adverse information of a business conglomerate in news media will result in a 10% percent reduction of activity levels. Another example would be to increase activity levels of accelerometers by 10% if they have been used for less than 10 hours. Operation 606 generally affects a small portion of entities 117.

System 100 establishes cutoffs for final determination for predictions from operation 604 of unscored data set 650. For example, in scored data set 660, 0 is an activity level for inactive sensor entities, and 1 is an activity level for active sensor entities. The predictions for sensor entities from operation 604 of unscored data set 650 is a numeric value between 0 and 1.0. In scored data set 660 for business entities, 0 is an activity level for least active entities (minimum), and 7 is an activity level for most active entities (maximum), as shown in TABLE 9. Recall, from TABLE 9, that activity level of 7 is for a large publicly traded company. Before final determination, the predictions for business entities from operation 604 of unscored data set 650 is rescaled linearly to a numeric value between 0 (minimum) and 1.0 (maximum). The cutoffs can also be determined by user 157 based on experience. TABLE 13 can be used for final determination of the unscored data set 650.

TABLE 13 shows the final determination (Activity Status) for a range of activity scores. If activity score 240 for an entity, e.g., entity 115, is in the lowest range, 0 to 0.24, an immediate action of replacing the sensor is recommended. For the range of 0.25 to 0.49, repair and maintenance are recommended. The other two ranges indicate healthy values. For business entities in the lowest range, no credit or marketing products are recommended. For the range of 0.25 to 0.49, user 157 needs to carefully consider before making credit or marketing decisions.

TABLE 13
Activity status for different scores

| Activity Scores | Activity Status |
|---|---|
| 0.75-1.0 | High Activity |
| 0.50-0.74 | Medium Activity |
| 0.25-0.49 | Low Activity |
| 0-0.24 | Inactive |

The output delivered to user 157 can also be the final raw predictions from activity analyzer 235, or a mathematically scaled version.

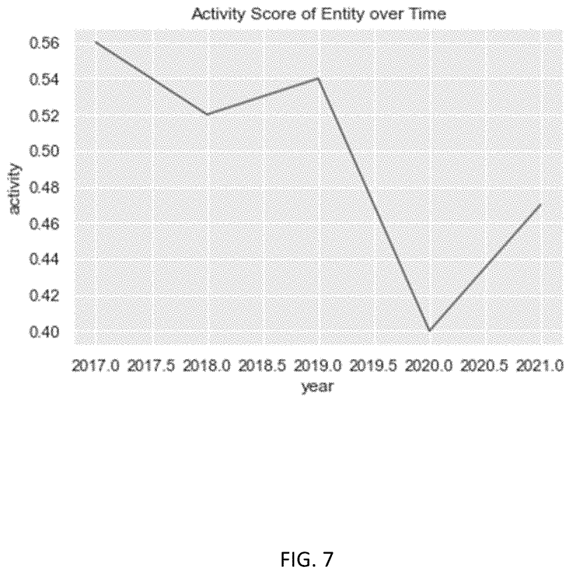

FIG. 7 is a graph of an activity score of an entity, over time. The output delivered to user 157, via user device 155, can be a time plot with X-axis as time and Y-axis as numeric predictions from activity analyzer 235, as shown in FIG. 7. The time plot can also have arrows indicating slope.

Based on relative changes of the activity score 240, rather than the absolute raw predictions, user 157 can decide whether any action needs to be taken.

The output, i.e., activity score 240 or a recommendation based thereon, delivered to user device 155, and thus to user 157, can be over a network (such as a cloud), e.g., network 150. The output can be a continuous stream of data, with updates at a fixed time interval, such as 24 hours. User 157 may only visually see the determination from TABLE 13, a single numeric activity score or a time-plot.

Technical benefits of system 100 include providing advance notice to device 155 about one or more deteriorating entities 117, better predictions because of the random generator in operation 602, and better understanding of key attributes causing a change in the activity level of one or more of entities 117.

Thus, among the features of system 100 is that:
1. source data analyzer 220 measures the accuracy of sources 132 and prepares a scored data set 660;
2. source data analyzer 220 helps separate entities 117 into scored data 660 and unscored data 650 using the accuracy of sources 132;
3. operation 505 describes entity 105 using weighted statistics as part of entity feature generator 225;
4. operation 505 describes entity 105 using unweighted statistics as part of entity feature generator 225;
5. random experiment generator 602 quantifies performance of multiple deep learning and machine learning techniques enabling selection of best hyperparameters of a deep learning or machine learning model;
6. random experiment generator 602 eliminates attributes that are not improving the loss function of the AI/ML method;
7. random experiment generator 602 allows both controlled and random experiments to producing reproducible results.

Thus, in system 100, pursuant to instructions in program module 175, processor 165 performs operations of:
receiving source data 210 from a source, e.g., source 120, about a plurality of entities, e.g., entities 117;
analyzing, in operation 220, source data 210 to produce (a) a source data assessment 222 that indicates whether to include source data 210 in a scored data set 660, and (b) a calculated accuracy 223 that is a weighted accuracy assessment of source data 210;
receiving entity data 215 about an entity of interest, e.g., entity 105;
generating, in operation 225, from entity data 215 and calculated accuracy 223, an entity description 230 that represents attributes of the entity of interest;
analyzing, in operation 235, source data assessment 222 and entity description 230 to produce an activity score 240 that is an estimate of an activity level of the entity of interest; and
issuing a recommendation, for example, to user device 155, concerning treatment of the entity of interest based on activity score 240.

In a case where the entity of interest is a device, the recommendation may be a recommendation of a maintenance action concerning the device.

In a case where the entity of interest is a business, the recommendation may be a recommendation of whether to extend credit to the business.

In operation 220, analyzing source data 210 includes, in operation 401, measuring accuracy of source data 210 against a verified population sample, thus yielding a measured accuracy.

In operation 220, analyzing source data 210 further includes, in operation 402, ranking accuracy of source data 210 based on the measured accuracy.

In operation 225, generating entity description 230 includes, in operation 505, calculating statistics concerning the entity of interest, over a window of time.

In operation 235, analyzing source data assessment 222 and entity description 230 includes utilizing a technique such as deep learning and/or machine learning, and generating reproducible results for the technique.

The following simple example will show how to calculate the activity score for many entities. The activity of an entity is determined by entity data and data provided by sources. An entity could be a pizza shop, namely Joe's Pizza, with a DUNS number 12345. Entity data includes firmographic attributes such as age of business, industry code, location, number of branches etc. Sources providing information about Joe's Pizza could be banks (B1,B2,B3, etc.), insurance companies (I1,I2,I3, etc.), telecommunications companies (T1,T2,T3, etc.), food distributing companies (F1,F2,F3, etc.). These different sources provide data with different levels of accuracy. As the activity score is determined by the data from the sources, the accuracy of the score is sensitive to the accuracy of the data from the sources.

The first step for calculating accuracy of sources involves quantifying the accuracy of the data from all sources (B1,B2,B3,I1,I2,I3,T1,T2,T3, F1,F2,F3, etc.) against a small sample of verified entities. For this example, let's assume the sample size is 1500 entities. Manual verification of these 1500 entities show 1000 entities are active and 500 entities are inactive. For active businesses, wherever possible, additional information is also collected to indicate levels of activity. An example of additional information is financial information. Using these verified samples as reference, the number of correct and incorrect is calculated for each of the sources. The ratio of correct to incorrect is the accuracy assessment for each data source. For example, if Source B1 has 650 correct, 50 incorrect and 800 no information among the 1000 verified active entities, then its accuracy assessment is (650)/(50+650)=0.929. Similarly, if Source B2 has 550 correct, 400 incorrect and 550 no information among the 1000 verified active entities, then its accuracy assessment is (550)/(550+400)=0.579. All the sources are ranked based on the accuracy assessment.

The accuracy assessment is used for entity description. Data from higher accuracy sources is given more weight. Such weights are used to calculate aggregates such as mean, sum, count over a time period for each entity. The aggregates over multiple time periods are combined for each entity column-wise. Similar aggregates are calculated for multiple entities row-wise. These rows and columns of a table are used for further separation into a scored data set and an unscored data set.

Quality of deep learning/machine learning models is sensitive to training data. Accuracy assessment is used to separate scored and unscored data sets. The scored data set will include only those entities where the information was provided by high quality data sources. Continuing from the previous example, the 700 entities (650 correct+50 incorrect) where information was provided by B1 are included in the scored data set. The levels or scores for scored data set is also provided by B1.

The scored data set is used for training purposes in a deep learning or machine learning model. As models tend to over-fit to a training dataset, multiple validation datasets are used to prevent over-fitting. The validation data sets are those subsets of the scored data set that have not been used for training. Non-deterministic operations are chosen wherever possible to obtain reproducible results. Predictions from different models for a single entity, e.g., Joe's Pizza, are averaged to get a final activity score. Based on a determination table, an action is recommended, such as offering of a credit product.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method comprising:
receiving source data from a source about a plurality of entities;
analyzing said source data to produce (a) a source data assessment that indicates whether to include said source data in a scored data set, and (b) a calculated accuracy that is a weighted accuracy assessment of said source data;
receiving entity data about an entity of interest;
generating, from said entity data and said calculated accuracy, an entity description that represents attributes of said entity of interest;
analyzing said source data assessment and said entity description to produce an activity score that is an estimate of an activity level of said entity of interest; and
issuing a recommendation concerning treatment of said entity of interest based on said activity score.

2. The method of claim 1, wherein said analyzing said source data comprises measuring accuracy of said source data against a verified population sample, thus yielding a measured accuracy.

3. The method of claim 2, wherein said analyzing said source data further comprises ranking accuracy of said source data based on said measured accuracy.

4. The method of claim 1, wherein said generating comprises calculating statistics concerning said entity of interest, over a window of time.

5. The method of claim 1, wherein said analyzing said source data assessment and said entity description comprises:
utilizing a technique selected from the group consisting of deep learning and machine learning; and
generating reproducible results for said technique.

6. The method of claim 1, wherein said entity of interest is a device, and said recommendation is a recommendation of a maintenance action concerning said device.

7. The method of claim 1, wherein said entity of interest is a business, and said recommendation is a recommendation of whether to extend credit to said business.

8. A system comprising:
a processor; and
a memory that contains instructions that are readable by said processor to cause said processor to perform operations of:
receiving source data from a source about a plurality of entities;
analyzing said source data to produce (a) a source data assessment that indicates whether to include said source data in a scored data set, and (b) a calculated accuracy that is a weighted accuracy assessment of said source data;
receiving entity data about an entity of interest;
generating, from said entity data and said calculated accuracy, an entity description that represents attributes of said entity of interest;
analyzing said source data assessment and said entity description to produce an activity score that is an estimate of an activity level of said entity of interest; and
issuing a recommendation concerning treatment of said entity of interest based on said activity score.

9. The system of claim 8, wherein said analyzing said source data comprises measuring accuracy of said source data against a verified population sample, thus yielding a measured accuracy.

10. The system of claim 9, wherein said analyzing said source data further comprises ranking accuracy of said source data based on said measured accuracy.

11. The system of claim 8, wherein said generating comprises calculating statistics concerning said entity of interest, over a window of time.

12. The system of claim 8, wherein said analyzing said source data assessment and said entity description comprises:
utilizing a technique selected from the group consisting of deep learning and machine learning; and
generating reproducible results for said technique.

13. The system of claim 8, wherein said entity of interest is a device, and said recommendation is a recommendation of a maintenance action concerning said device.

14. The system of claim 8, wherein said entity of interest is a business, and said recommendation is a recommendation of whether to extend credit to said business.

15. A storage device that is non-tangible, comprising:
instructions that are readable by a processor to cause said processor to perform operations of:
receiving source data from a source about a plurality of entities;
analyzing said source data to produce (a) a source data assessment that indicates whether to include said source data in a scored data set, and (b) a calculated accuracy that is a weighted accuracy assessment of said source data;
receiving entity data about an entity of interest;
generating, from said entity data and said calculated accuracy, an entity description that represents attributes of said entity of interest;
analyzing said source data assessment and said entity description to produce an activity score that is an estimate of an activity level of said entity of interest; and
issuing a recommendation concerning treatment of said entity of interest based on said activity score.

16. The storage device of claim 15, wherein said analyzing said source data comprises measuring accuracy of said source data against a verified population sample, thus yielding a measured accuracy.

17. The storage device of claim 16, wherein said analyzing said source data further comprises ranking accuracy of said source data based on said measured accuracy.

18. The storage device of claim 15, wherein said generating comprises calculating statistics concerning said entity of interest, over a window of time.

19. The storage device of claim 15, wherein said analyzing said source data assessment and said entity description comprises:
utilizing a technique selected from the group consisting of deep learning and machine learning; and
generating reproducible results for said technique.

20. The storage device of claim 15, wherein said entity of interest is a device, and said recommendation is a recommendation of a maintenance action concerning said device.

21. The storage device of claim 15, wherein said entity of interest is a business, and said recommendation is a recommendation of whether to extend credit to said business.
